(19) United States
(12) Patent Application Publication
(10) Pub. No.: US 2007/0288593 A1
(43) Pub. Date: Dec. 13, 2007

(54) Chargeable peer-to-peer file download system

(75) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/502,287

(22) Filed: Aug. 10, 2006

(30) Foreign Application Priority Data
Jun. 12, 2006 (CN) 200610091747.8

(51) Int. Cl. G06F 15/16; G06F 15/173

(52) U.S. Cl. 709/217; 709/223

(57) ABSTRACT

A server terminal is interconnected with a number of client/peer terminals, as part of a network. For chargeable peer-to-peer file downloads, a client terminal establishes and accesses an account on the server. An information file associated with a data file of interest is obtained by the client from the server. The information file contains the network address of a tracker module. The client terminal accesses the tracker module to obtain the network locations of one or more peer terminals having sections/pieces of the data file stored thereon. The client terminal selects and contacts peer terminals for obtaining the data file sections. The client terminal and/or selected peer terminals securely transmit accounting data, relating to the amount of data transferred, to the tracker module, which forwards it to the server for billing purposes.

This application is entitled to the benefit of and claims foreign priority under 35 U.S.C. § 119 from Chinese Patent Application No. 200610091747.8, filed Jun. 12, 2006, the disclosure of which is hereby incorporated by reference.

### FIELD OF THE INVENTION

The present invention relates to communications and, more particularly, to file transfer services on a packet data or other communication network.

### BACKGROUND OF THE INVENTION

Wide-area, packet-data computer networks such as the Internet directly or indirectly interconnect a large number of computer terminals and other electronic devices to one another over large geographic areas. This allows information and data to be shared among a number of terminals and users in an efficient and distributed manner. In addition to transferring data for communication purposes, e.g., website-related packet data or the like, the Internet and similar packet data networks are increasingly used to transfer large data files from one terminal to another. For example, as the available data bandwidth has increased (with correspondingly faster data transfer rates), the Internet is now utilized to obtain electronic music files, books and other text and graphic files in electronic format, video clips, and even full-length movies, in lieu of obtaining these materials from conventional sources such as “brick-and-mortar” stores. FIG. 1A shows a first commonly used file download/transfer system, for providing large data files for download over the Internet or other network 10. As indicated, a number of client terminals 12a-12e are connected to the network 10 in a standard manner. A server terminal 14 is also connected to the network 10 in a standard manner. (In this context, the server terminal is a terminal providing the data files, whereas the client terminals are terminals obtaining the data files from the server. As should be appreciated, a terminal may be configured to act in both a client and server capacity.) The server terminal 14 includes a database and/or mass storage 16 such as a hard disk or disk array. The database 16 includes a number of data files 18a-18c. In operation, the client terminals 12a-12e contact the server terminal 14 over the network 10, in a standard manner, for obtaining selected data files 18a-18c. After one or more optional administrative functions (e.g., requiring the client terminal to provide electronic payment for the file), the requested files 18a-18c are transferred over the network 10 to the client terminals 12a-12e, as indicated by the single-direction arrow “A.” (Typically the files 18a-18c will be broken into packets for transmission over the network, and then reassembled at the client end for storage and use.)

While the traditional server-client configuration shown in FIG. 1A is generally effective on a small or medium scale, problems may arise when the number of users/clients increases. For example, there will typically be a higher demand for computing/processor power, storage space, and data transfer bandwidth, which may require that the server be outfitted with additional storage, processing, and bandwidth resources, or that more than one server terminal be provided for the file download system. Additionally, the download system is dependent on the server for operation. If the server's resources are overtaxed, file transfer times may suffer. Similarly, if the server fails, the entire system fails.

FIG. 1B shows a second commonly used file download/transfer system, oftentimes referred to as a “peer-to-peer” or “P2P” filing-sharing network. The peer-to-peer network includes a number of “peer nodes” 20a-20f, each of which is a computer terminal or other terminal connected to a network 10 such as the Internet. (Generally speaking, the peer nodes correspond to the client terminals 12a-12e shown in FIG. 1A, with the exception that there is no client-server relationship per se.) The peer nodes 20a-20f are provided with a means for determining which data files are stored on each peer node. For example, each node may be provided with the addresses of the other nodes for obtaining lists of the data files stored on the other nodes. When a file of interest is found on one of the lists, the two nodes establish an ad hoc communication connection (e.g., the connection is generated just for the purposes of transferring a file), and the file is transferred “directly” from one node to the other. That is, the file is transferred directly except for any ephemeral interconnection points required for data transfer over the network 10. (For example, in a typical Internet connection, data is sent from an originating terminal through a chain of intermediate terminals until the data reaches its destination.) Alternatively, one of the peer nodes 20f (acting in a capacity similar to a server terminal 14) may include a general index 22 containing a plurality of listings 24a-24c. Each listing 24a-24c identifies a data file and the network addresses of the peer nodes on which the data file is stored. For a user to find a particular data file, the index 22 is accessed from the user's peer node/terminal. Once the address of the file is found, an ad hoc connection is established between the user's node and the peer node on which the file is stored. The file is then directly transferred between the two nodes over the network 10, as indicated by the bidirectional arrow “A,” indicating direct transfer between terminals through the network.

A peer-to-peer file-sharing network relies primarily on the computing power and bandwidth of the participants in the network rather than concentrating it in a relatively low number of server terminals. As such, there is very little if any reliance on centralized services or resources for file transfer operations. Additionally, peer-to-peer systems can survive extreme changes in network composition, and are well adapted for use with a heterogeneous mixture of network components. However, peer-to-peer file transfers monopolize network resources without the opportunity for creating additional revenue. In particular, it is estimated that seventy percent (70%) or more of broadband data traffic is taken up by the download/transfer of music files, game files, video files, and similar content. The consumption of network bandwidth will only increase as the number of peer-to-peer users increases, as the number of file downloads increases, and as file sizes increase. The process of identifying peer-to-peer applications and/or instances of peer-to-peer file transfer is complex. Sophisticated peer-to-peer protocols can dynamically hop to different communication ports, making them difficult to detect, monitor, and control. Many existing devices and unsophisticated service control technologies lack the ability to detect changing peer-to-peer protocols, hampering a network service provider's ability to address peer-to-peer application management. Peer-to-peer systems also suffer from the possibility of copyright infringement if users engage in the unauthorized transfer of copyrighted material. As such, to the extent service providers are able to detect peer-to-peer usage, management of this usage may involve simply blocking the peer-to-peer traffic.

### SUMMARY OF THE INVENTION

An embodiment of the present invention relates to a system for chargeable peer-to-peer file transfer or download. The system includes a server terminal, a plurality of client/peer terminals, and, optionally, a tracker module, all of which communicate over a network. By “terminal,” it is meant an electronic device capable of communicating over a network. The tracker module is a network-connected software- and/or hardware-based application or program, acting as an agent of the server terminal, for carrying out certain communication and other functions of the file transfer/download system. In operation, the server terminal and/or tracker module transmits the network address or other location of a data file to a first client terminal desirous of obtaining the data file. The data file is stored on a second client terminal, e.g., on a peer terminal. Based on the location, the first client terminal obtains the data file from the second client terminal, in a peer-to-peer manner. One or both of the client terminals transmit accounting data to the server terminal and/or to the tracker module. The accounting data relates to the transfer of the data file from the second terminal to the first terminal over the network. For example, the accounting data may include a data transfer rate and the amount of data transferred over the network.

In another embodiment, the data file is divided into a number of pieces or sections, which may be stored on different peer terminals. In operation, the server terminal and/or tracker module transmits the network address or other location of each section of the data file to a first client terminal desirous of obtaining the data file. Based on the locations, the first client terminal obtains all the sections of the data file from the other client terminals, in a peer-to-peer manner. All the peer terminals transmit accounting data to the server terminal and/or to the tracker module. The data file sections are verified and re-assembled into the data file according to hash information made available to the first client terminal.

In another embodiment, the accounting data is automatically securely generated and transmitted during or subsequent to when the data file (or data file section) is obtained. By “automatically,” it is meant without user input or initiation, and by “securely” it is meant without the possibility of user intervention or modification, including possible secure transmission over the network. For this purpose, the client terminals may be provided with a client module (e.g., a software- and/or hardware-based application or program) that coordinates, from the client terminal end, (i) communication with the server terminal and/or tracker module, (ii) peer-to-peer file transfer, and (iii) generating and transmitting the accounting data.

In another embodiment, the accounting data is used by the server terminal for generating billing data, e.g., based on the data transfer rate and/or data transfer volume. By “billing data,” it is meant information/data relating to monetary or similar charges (e.g., credits or debits) applied against a user or user account. Typically, users who obtain a file or file portion from a peer terminal are charged a fee for the file transfer. The peer terminal that transmits the file may be given a credit for transmitting the file.

In another embodiment, the establishment of a secure account on the server is required for using the system for peer-to-peer file transfer. By “secure account,” it is meant an account (e.g., grouping of related data organized under an account name), the access of which is restricted based on security features such as account identifier and password protection. After establishing an account, for obtaining a data file the client terminal accesses the account on the server. Subsequently, the client terminal accesses a database on the server for obtaining an information file from the server. The information file is associated with the data file, and may include information relating to the data file. The information file may also include a network address or other location of the tracker module for obtaining the location of the data file from the tracker module, or the respective locations of data file portions if the data file is divided into different portions stored on different peer terminals. Typically, the tracker module will have the most up-to-date information regarding the location of each piece/portion of the data file.

In another embodiment, the file to be downloaded is made available by server or peer terminals in the network, by publishing the network address of the file, and/or by providing an information file on the tracker and/or server. The data file is split into pieces/sections each with the same size or thereabouts, and its information file on the tracker module or server contains the network location of each piece/portion of the data file.

In another embodiment, the peer terminals that are downloading the data file will contact the tracker module(s) periodically, informing the tracker module(s) about which pieces/sections of the data file are already downloaded and available for other peer terminals to download.

In another embodiment, after requesting the location of a data file, a client terminal receives a number of network locations from the tracking application and/or server terminal, e.g., listed in a peer list. The locations are associated with peer terminals in the system that have the data file available for peer-to-peer transfer (or, if the data file is divided into sections, the locations of the peer terminals having the data file sections). The client terminal selects one or more of the peer terminals from which to obtain the data file or data file sections.

As should be appreciated, the system utilizes a peer-to-peer network model for file download, and an account-based client-server network model for managing file downloads and gathering billing information. Thus, the system is efficient in terms of file transfer while maintaining accuracy, security, and accountability in terms of network bandwidth usage and billing.

### BRIEF DESCRIPTION OF THE DRAWINGS

The present invention will be better understood from reading the following description of non-limiting embodiments, with reference to the attached drawings, wherein below:

FIGS. 1 A and 1B are schematic views of file transfer/download systems according to the prior art;

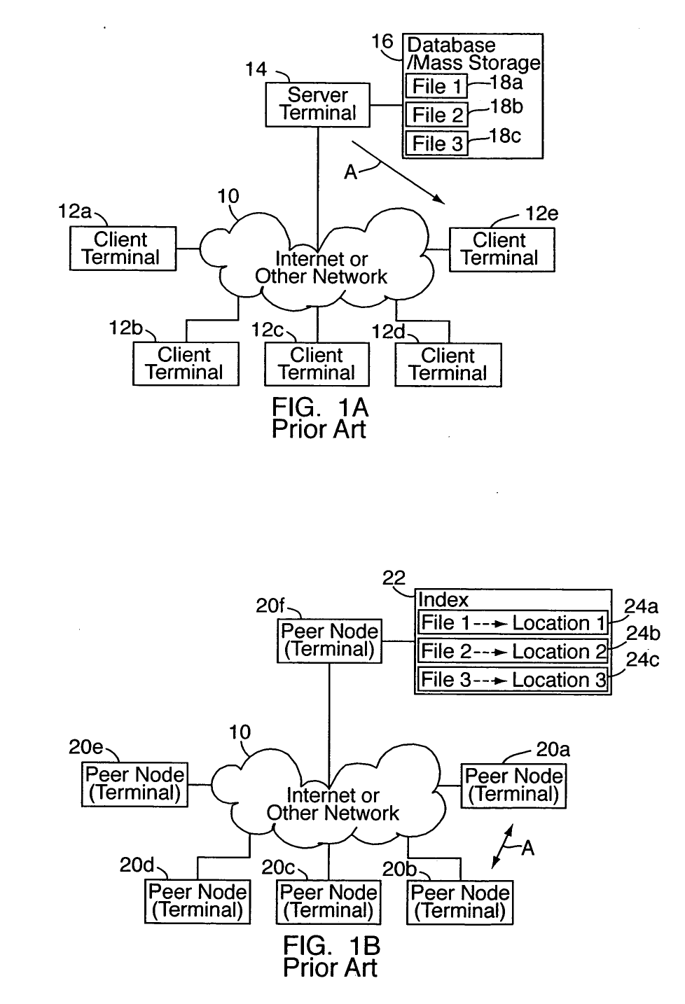

FIGS. 2A and 2B are schematic views of a file download system according to various embodiments of the present invention;

FIG. 3 is a schematic view showing message flow in the file download system; and

FIGS. 4A and 4B are flowcharts showing the file download system in operation, according to an embodiment of the present invention.

### DETAILED DESCRIPTION

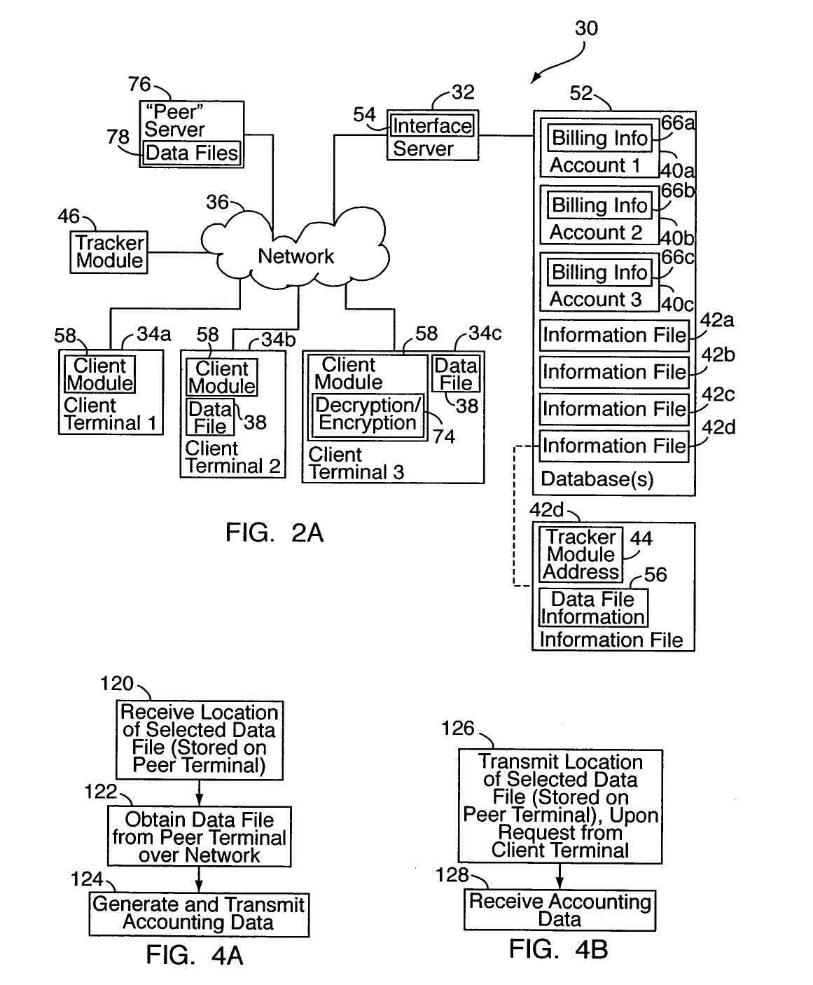

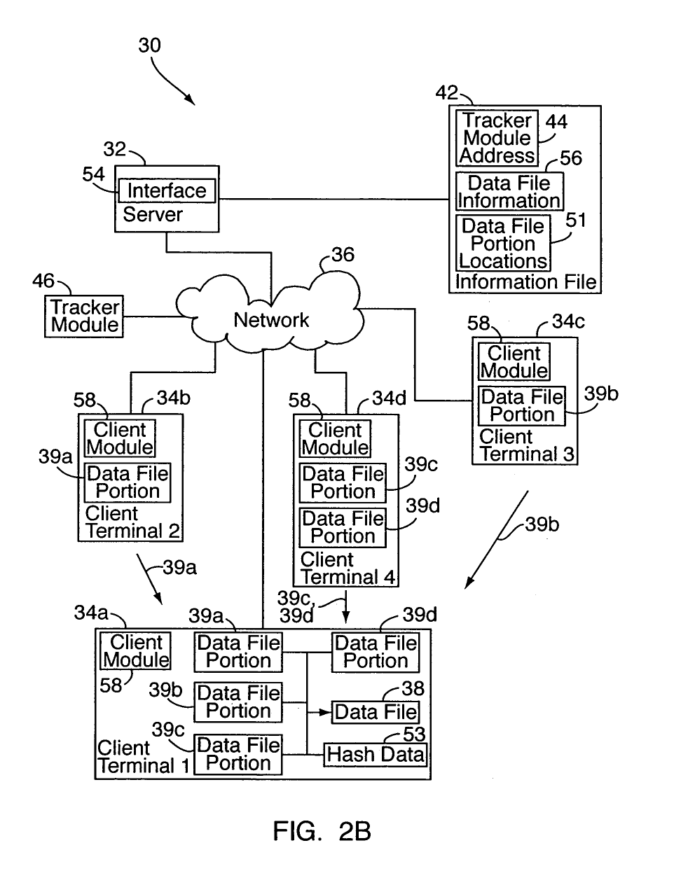

With reference to FIGS. 2A and 3-4B, a chargeable peer-to-peer file download system 30 includes a server terminal 32 and a number of client or peer terminals 34a-34c interconnected by a network 36. For one of the client terminals 34a to obtain a data file 38 over the system 30, the client terminal 34a accesses the server 32 through a pre-established account 40a. Typically, each client terminal 34a-34c will have an account 40a-40c on the server, with the establishment of an account being required for using the system 30. The client terminal 34a obtains an information file 42a associated with the data file 38, which is one of a plurality of information files 42a-42d on the server, one for each data file available for download. The information file 42a contains the network address or other location 44 of a tracker module 46. The client terminal 34a accesses the tracker module 46 to obtain the network locations 48a, 48b (see FIG. 3) of one or more of the terminals 34b, 34c that have the data file 38 stored thereon. The client terminal 34a selects and contacts one of these terminals 34b for obtaining the data file 38, that is, after being contacted by the terminal 34a the terminal 34b transmits the data file 38 to the terminal 34a over the network 36. The client terminal 34a securely transmits accounting data 50, relating to the amount of data transferred over the network 36, to the tracker module 46, which forwards it to the server 32 for billing purposes. The accounting data 50 may also contain an indication that the file has been obtained at the client terminal 34a and is available for download from the terminal 34a by other terminals. As should be appreciated, the system 30 utilizes a peer-to-peer network model for file download, and an account-based client-server network model for managing file downloads and gathering billing information. Thus, the system is efficient in terms of file transfer while maintaining accuracy, security, and accountability in terms of network bandwidth usage and billing.

With reference to FIG. 2B, the system 30 may be configured in a manner used in certain peer-to-peer networks where data files 38 for downloading are divided into a number of portions or sections 39a-39d, each about the same size, which are distributed among a number of peer terminals 34b-34d. Here, the client terminal 34a obtains an information file 42 associated with a data file 38 from the server terminal 32. (Typically, there will be one information file for each data file available for download over the system.) The information file 42 contains the network address or other location 44 of a tracker module 46. The client terminal 34a accesses the tracker module 46 to obtain the network locations 51 of the terminals 34b-34d that have the data file sections 39a-39d stored thereon. (Alternatively, the locations 51 may be contained in the information file 42.) If more than one terminal has the same data file section, the client terminal 34a chooses among the available choices. Based on the locations, the client terminal 34a obtains the sections 39a-39d of the data file 38 from the terminals 34b-34d, in a peer-to-peer manner. Once all the data file sections/portions are obtained, the data file sections 39a-39d are verified and re-assembled into the data file 38 according to hash information/data 53 made available to the client terminal 34a. The hash data is data used for verifying the data file sections 39a-39d, for reassembling the data file portions 39a-39d into a file 38, and/or for classifying the data file portions 39a-39d for purposes of quick and efficient database storage and retrieval. The hash data 53 may be obtained from the information file 42 associated with the file 38. One or more of the terminals 34a-34d will also typically transmit accounting data 50, which may also include an indication of which data file sections 39a-39d have finished downloading and are ready to be downloaded by other terminals.

The system 30 of the present invention is suitable for implementation in conjunction with various types of communication networks 36, including stand-alone networks and interconnected networks. For example, the network(s) 36 may include wire-line networks such as DSL networks, public switched telephone networks (PSTN), IP (Internet protocol)-based networks such as the Internet or other packet data networks, local area networks (LAN), and wireless networks such as those using CDMA, GSM, IEEE 802.11x, and/or UMTS communications or the like. The terminals 32, 34a-34d are electronic devices capable of communicating with one another over the network(s) 36, and may include, for example, computer terminals, wire-line connected communication devices such as conventional telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. The terminals 32, 34a-34d communicate with one another over the network 36 in a standard manner, depending on the network 36, the particular protocols used for communicating over the network, and the type of terminals used for accessing the network. In the case of computer terminals and an IP network, one terminal (e.g., a client terminal) sends a request for data to another terminal (e.g., a server terminal), and data from the server terminal is transferred back to the client terminal in packet form. For example, for accessing a website on the Internet, a user may enter a URI (uniform resource identifier)/URL (uniform resource locator) or IP address of the website into a web browser software program running on the user's computer terminal, e.g., Microsoft Internet Explorer™. The URL is a string of characters conforming to a standardized format, which refers to a resource on the Internet (such as the home page of the website) by its location, and which may specify the protocol to use to communicate, the host/server to communicate with, the network communication port on the server to connect to, and the path to the resource on the server (for example, its file name). Once the URL is entered, the server terminal is contacted and, if available, the server terminal transmits requested data back to the user's terminal, according to the particular URL. For example, if the URL corresponds to a website home page, data corresponding to the home page (typically in HTML format), as stored on the server, is transmitted back to the user's terminal. The data is translated/decoded by the web browser to recreate the webpage in graphical form on the user terminal's display.

The server terminal 32 is a standard server-configured terminal (or grouping of terminals) having communication means for communicating over the network, e.g., one or more standard network interface cards/modules, modems, or the like. The server terminal 32 also includes mass storage or other memory, which may be organized into one or more databases 52 for storing the accounts 40a-40c and information files 42a-42d. Typically, the server terminal 32 will also include an interface 54 for users to access the server 32 (from the client terminals 34a-34d) to establish accounts and the like. For example, the interface 54 may be an Internet website implemented in a standard manner as well known in the art, e.g., HTML code.

To establish an account 40a on the server for peer-to-peer file transfer, a user at a client terminal 34a accesses the interface 54. For example, if the interface 54 is an Internet website or the like, the user would activate a web browser program on the client terminal 34a and enter a URL of the interface 54 into the web browser. Having accessed the interface 54, the user is provided with options such as “establish new account” and “access existing account.” The user is also provided with information about the system 30, including billing options and rates. If the “establish new account” option is selected, the user is prompted to enter personal information and whatever other information is required for establishing the account, e.g., name, billing address, e-mail address, payment means such as bank account debit or credit card, and security information such as user name and password. This information is stored in a standard manner as one or more associated files in the database 52, as the user's account 40a. To subsequently access the account 40a, the user accesses the interface 54, selects the “access existing account” function (or the like), and enters the account and/or security information.

The server terminal 32 also includes the information files 42a-42d stored in the database 52, or otherwise accessible to the server terminal 32. The information files 42a-42d each correspond to a different data file 38 available for download/transfer on the system 30. (In other words, each data file 38 has a corresponding information file 42a-42d stored on the server 32.) Each information file 42a-42d includes the network address or other location 44 of a tracker module 46, e.g., a URL or IP address of the tracker module for accessing the tracker module over the network 36. The tracker module 46, as further described below, may be general purpose in nature, e.g., the tracker module is used in conjunction with more than one data file 38, or it may be individually dedicated or assigned to the data file 38. The information files 42a-42d further include information 56 about their respective associated data files 38, such as file name, file type, file size, subject matter and content summary, and billing information such as rates for obtaining the file, if applicable. For example, in the case of a song or music file, the file information 56 could include the file name, the name of the song, the album with which the song is usually associated, the artist, music genre, file size, file type, e.g., MP3, and the cost for downloading the music file. The information files may also contain hash data relating to the data file 38, or to each data file section 39a-39d if the data file is divided into sections for peer-to-peer transfer.

As an initial step in downloading a data file 38, a user directs the client terminal 34a to access the server 32 through the interface 54, as at Step 100 in FIG. 3, selects the “access existing account” option or the like, and enters the information required for accessing the user's account 40a. Subsequently, the user selects an option for selecting and/or downloading data files. Selecting a data file 38 may involve searching for the data file using key words or the like, searching for categories or groups of files, entering a file name or other identifier, if known, or browsing through a list or selection of available data files, possibly broken down by category, type, or genre. As such, the interface 54 may be provided with functionality for this purpose, such as a standard website search function, various linked web pages for browsing, one or more indices, or the like. Once a particular data file 38 is selected, the user selects a “download” function or the like, and may be asked to approve the billing rate or fee for downloading the file. Then, at Step 102 the information file 42a associated with the selected data file 38 is transferred from the server terminal 32 to the client terminal 34a over the network 36.

The information file 42a is used for purposes of contacting and communicating with the tracker module 46 identified in the information file 42a. For this purpose, the client terminal 34a will typically be provided with a client module 58. The client module 58 is a hardware, hardware/software, or software application/program running on the client terminal 34a and configured to communicate over the network 36 in a standard manner, e.g., the client module 58 accesses the client terminal's network communication means (network interface card, modem, etc.) to send and receive messages and other data over the network 36. The client module 58 may be a utility-like software program operating in the “background” of the client terminal user interface or operating system, and/or it may provide user-accessible functionality such as displaying download status, download history, and the like. It may also function as a client terminal-based interface for accessing the server terminal 32. Typically, the client module 58 will be downloaded from the server 32 when a user first establishes an account. The client module 58 is then installed onto the client terminal in a standard manner. Downloading and installing the client module may be required for using the system 30. Alternatively, the client module may be “built into” a client terminal. For example, in the case of a wireless unit, the client module could be provided as one of the standard available functions on the wireless unit, with the system 30 being operated by the wireless server provider of the wireless unit or a designated third party.

Once the information file 42a is received at the client terminal 34a, at Step 104 the client module 58 initiates communication with the tracker module 46 at the tracker module address/location 44 provided in the information file 42a. In particular, the client module 58 transmits a data file identifier 60 to the tracker module 46 and the tracker module responds with a peer list 64 of which terminals have the data file 38 or data file sections 39a-39d. The data file identifier 60 uniquely identifies the selected data file 38, and will typically be part of the data file information 56 in the information file 42a. For example, the data file identifier may be the file name of the data file, a serial or index number of the data file, or the like. In some systems, the client terminal 34a may also transmit contact information 62 to the tracker module. The client terminal contact information 62 includes whatever information is required for the tracker module 46 to communicate with the client terminal 34a, such as the network address of the client terminal (URL or IP address) and/or the communication port to which the client terminal is listening.

The tracker module 46 is a network-connected software- and/or hardware-based program/application, acting as an agent of the server terminal, for carrying out certain communication and other functions of the system 30. For example, the tracker module 46 may be provided for facilitating peer-to-peer contact for peer-to-peer data file transfer, for collecting accounting data 50 for billing purposes, and/or for tracking which terminals have obtained which data files (or data file sections 39a-39d) over the system. The tracker module 46 implements a simple communication protocol layered on top of HTTP (that is, implemented to operate in conjunction with the communication protocol in place on the network, such as HTTP) in which a client terminal sends the file identifier 60, and the tracker module responds with the peer list 64 containing the network locations/addresses 48a, 48b of client/peer terminals 34b, 34c having the selected data file 38 or, as the case may be, sections 39a-39d of the selected data file 38. The terminals identified in the peer list 64 may have previously downloaded (or be in the process of downloading) the selected data file 38 (or data file section) over the system 30, with the server terminal 32 and/or tracking module 46 having tracked information to that effect for subsequent peer-to-peer downloads initiated by other client terminals. (In other words, when a client terminal downloads a file or file section over the system, the server may be configured to note that the client terminal now has the file or file section available for peer-to-peer download, including storing the client terminal's network address for later providing to client terminals desiring to obtain the data file or file section.) Alternatively, the data file may originate with one of the identified peer terminals 34b, 34c, with that identified peer terminal having notified the server terminal 32 (e.g., from the client module, and/or by accessing the interface 54) that the data file is available for peer-to-peer transfer. In this case, measures may be put in place at the server terminal 32 for safeguarding copyright-protected files.

As noted, there may be one tracker module/application 46 used for all peer-to-peer transactions, or, since transaction volume may require more than one tracker module, there may be a plurality of tracker modules 46 that are assigned to transactions as needed. Alternatively, there may be a tracker module 46 associated with each data file 38, with the tracker module being dedicated for transactions involving that data file. In such a case, it would not be necessary for a client terminal to transmit the file identifier 60 to the tracker module. Instead, the data file for downloading would be implied by the client terminal having contacted the particular tracker module. The tracker module(s) 46 may be stored on the server terminal 32 or on another network-connected terminal.

When the tracker module 46 receives the identifier 60 of a selected data file 38 and/or client module contact information 62 from a client terminal 34a, the tracker module 46 responds by sending a peer list 64 to the client terminal 34a, as at Step 106. The peer list 64, as noted, contains a list of the network addresses/locations 48a, 48b of one or more peer terminals having the selected data file 38 or data file sections 39a-39d. These may be all or some subset of the terminals having the selected data file 38 or file sections 39a-39d on the system 30, or only those terminals currently in active communication with the network. Subsequently, the client module 58 (running on the client terminal 34a) selects one of the listed peer terminals if downloading the complete file 38, or one or more of the peer terminals if downloading multiple file sections 39a-39d. The selection may simply be the first active terminal listed in the peer list, or the active peer terminal “closest” to the client terminal 34a on the network 36. Other selection criteria are possible. Peer-to-peer file transfer commences once a peer terminal has been selected, e.g., peer terminal 34b. In particular, at Step 108 the client module 58 initiates communication with the selected peer terminal 34b over the network 36 at the location/address 48a of the peer terminal 34b provided in the peer list 64. For example, this may include transmitting a peer-to-peer file request message 65 to the peer terminal 34b. In response, at Step 110 the client module in place on the selected peer terminal 34b causes the selected data file 38 (or data file section 39a), stored on the peer terminal 34b, to be transmitted to the client terminal 34a in a standard manner. The data file 38 (or data file section 39a) is received at the client terminal 34a and stored for retrieval and subsequent use. If the data file 38 is obtained as a plurality of data file sections 39a-39d, this process is repeated for other peer terminals until all the sections are obtained.

During or subsequent to file or file section transfer, and at least periodically, one or both of the client modules 58 in place on the selected peer terminal 34b and client terminal 34a transfers accounting data 50 to the tracker module 46 (Step 112). The accounting data 50 may include data 68 relating to data transfer rates of the transferred file 38, data 70 relating to the volume of data transferred, and data 72a, 72b identifying the client terminal 34a, peer terminal 34b, and/or the accounts 40a, 40b associated with these terminals. Typically, the transfer rates will be used for statistics purposes, and the data volumes will be used for traffic recording for billing purposes, e.g., billing may be based on the amount of data transferred as opposed to the rate of transfer. Alternatively, users may select a burst transfer rate, which would be billed at a higher rate, or the accounting data may simply indicate that a file has been successfully transferred, if billing is on a per-file basis. Accounting data may be generated and/or used in terms of both upload and download volumes, the latter referring to data received at the requesting client terminal 34a and the former referring to data transferred by the peer terminal 34b. Upload volumes may be used as a basis for billing credits for peer terminals, e.g., peer terminals may, in effect, be paid or credited a small amount for acting as data sources in the system 30, thereby providing an incentive for users of peer terminals to consent to subsequent file transfer to other peer terminals. Typically, the accounting data 50 will be transmitted to the tracker module and/or server terminal in a secure manner such as symmetric encryption, for ensuring that the accounting data is not modified by the user of the client terminal 34a. As should be appreciated, in this manner the generation and transmission of accounting data is performed automatically and without the possibility of user intervention, with use of the client module (and compartmentalized/secure generation of accounting data) being a prerequisite for using the system for peer-to-peer file transfer. Additionally, because each peer user is required to establish a secure account and to use the client module, a secure/trusted peer-to-peer network is established wherein the collection of fees for peer-to-peer data traffic is ensured. In the case of a client terminal 34a obtaining data file sections 39a-39d from multiple terminals 34b-34d, each terminal 34a-34d may generate accounting data 50.

If the accounting data 50 is transmitted to the tracker module 46, the tracker module forwards the data 50 to the server terminal 32, as at Step 114. The server terminal 32 uses the accounting data 50 to generate billing data 66a-66c. By “billing data,” it is meant information/data relating to monetary or similar charges (e.g., credits or debits) applied against a user or user account. Thus, the billing data 66a-66c may be based on the data transfer rates 68 and/or volumes 70, and may include, for example, monetary charges to or against the account(s) identified in, or determinable from, the accounting data 50. For example, if billing rates are based on data volume 70, then an account 40a may be charged a dollar amount as follows:

$charge=(data volume)×($/unit data)

This information is stored as the billing data 66a-66c in the users' respective accounts 40a-40c, with funds being obtained by the system 30 in a standard manner according to the user agreement and account type, e.g., a direct banking account debit, a credit card charge, or the like. Funds collected by the system 30 may be used to pay for copyright licensing fees, and to pay the network service provider for network bandwidth.

As noted, each time a peer terminal obtains a particular data file or data file section, the network address or other location of that terminal is tracked by the tracker module 46 and/or server terminal 32 in association with the data file or data file section. In other words, the tracker module and/or server stores data (e.g., in a database or other storage) associating the address/location of the peer terminal with the data file (or particular pieces/sections of the data file), as an indication that the peer terminal has the data file available for peer-to-peer transfer. When another peer terminal later requests the data file or file section, the database or other storage is searched or otherwise accessed, in relation to the data file, to compile a relevant peer list 64 for the data file. Inclusion in the peer list may depend on whether the terminal is in communication with the network, and as such the tracker module and/or server terminal may perform a test for this condition. Alternatively, a client terminal can select an alternative peer terminal on the peer list if one is found to be unavailable for file transfer.

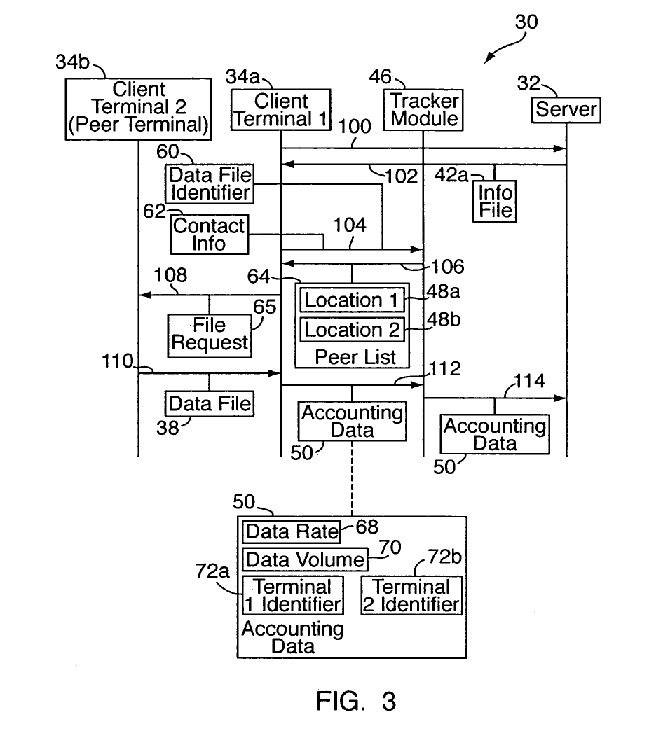

From the perspective of a client terminal 34a and/or client module 58, for the case of transferring a complete file 38, operation of an embodiment of the system 30 is summarized in FIG. 4A. At Step 120, the client terminal receives the location of a selected data file 38 from the tracker module/application 46 or the server terminal 32. The location may be the network address or other location of the peer terminal 34b on which the data file is stored, or it may be an address or other location of the data file itself, e.g., a sub-address or location on the peer terminal 34b. At Step 122, the client terminal 34a obtains the data file 38 from the peer terminal 34b over the network 36. At Step 124, the client terminal 34a transmits accounting data 50 to the tracker module/application 46 and/or to the server terminal 32. As noted, the accounting data 50 relates to the transfer of the data file from the peer terminal to the client terminal over the network, e.g., data transfer rates and/or data transfer volume. Typically, the accounting data will be automatically securely generated and transmitted during or subsequent to when the data file is obtained. In other words, upon obtaining the data file, the client module automatically (e.g., without user input) and securely (e.g., without the possibility of user intervention) generates the accounting data and automatically and securely transmits it (e.g., secure transmission such as encryption) to the tracker module or server.

For the case of multiple data file sections 39a-39d, the client terminal 34a receives the locations of the sections 39a-39d of a selected data file 38 from the tracker module/application 46 or the server terminal 32. For example, the locations may be the network addresses or other locations of the peer terminals 34b-34d on which the data file sections 39a-39d are stored. The client terminal 34a obtains the data file sections 39a-39d from the peer terminals 34b-34d over the network 36. The terminals 34a-34d transmit accounting data 50 to the tracker module/application 46 and/or to the server terminal 32.

From the perspective of the tracker module 46 or server terminal 32, operation of an embodiment of the system 30 is summarized in FIG. 4B. At Step 126, the server and/or tracker module transmits the network address or other location of a selected data file 38 to a client terminal 34a, upon request from the client terminal 34a. The data file 38 is stored on a peer terminal 34b. Later, at Step 128, the server terminal and/or tracker module receives accounting data 50 from either or both the client terminal 34a and the peer terminal 34b. The accounting data 50 relates to the transfer of the data file from the peer terminal to the client terminal over the network, e.g., data transfer rates and/or data transfer volume. In the case of data file sections 39a-39d, the server and/or tracker module transmits the network addresses or other locations of the data file sections 39a-39d to a client terminal 34a, upon request from the client terminal 34a. The data file sections 39a-38d are stored on peer terminals 34b-34d. Typically, the server terminal and/or tracker module will receive accounting data 50 from all the terminals 34a-34d.

The system 30 may be provided with encryption and/or anti-copying measures whereby the data files 38 or file sections can only be transferred to others through the system 30. For example, the system could be configured such that each time a data file is copied or transferred, the file either automatically self-encrypts or is automatically encrypted by the client module, with the client modules 58 having functionality 74 for decrypting the file for use. Thus, users would be prevented from transferring the data files 38 in a useable form outside the system 30, which might result in copyright infringement, violation of licensing contracts, or the like.

As should be appreciated, the data files 38 may originate with the server terminal 32. For example, music or other data files 38 could be cleared for copyright licensing purposes, and then stored on the server terminal 32. The first time a file (or file section) stored on the server was downloaded, the file or file section would be transferred from the server terminal to the downloading client terminal, in a manner similar to as described above, e.g., the server terminal would function, in effect, like a peer terminal. Alternatively, instead of files being stored on and transferred from the server terminal 32 itself, there could be a dedicated “peer” server 76, configured to function in a manner like a true peer terminal 34b, 34c, for storing and downloading data files 78 in the first instance. The network address or other location of the peer server 76 would be provided in a peer list or the like, as described above. Subsequent to a data file 38 or data file section being downloaded from the server 32 or peer server 76, the server 32 or peer server 76 would be excluded from subsequent peer lists, with the data file 38 instead being transferred peer-to-peer. Alternatively, the server and/or peer server could act as a “backup” in case no peer terminals were, available for downloading a particular data file or file section.

Although the tracker modules 46 facilitate an efficient division of communication functions in the system 30, the system 30 could instead be configured for operation solely with the server terminal or terminals 32, without departing from the spirit and scope of the present invention. Thus, the server terminal(s) could be configured for carrying out the functions of the tracker modules described above, with the client/peer terminals communicating directly with the server terminal(s) in all instances except for peer-to-peer file transfer.

As should be appreciated, although the data file sections 39a-39d have been characterized as portions or sections of a data file 38, each data file portion is itself a data file, e.g., grouping of data. As such, the data file portions may be characterized as data files, with the data file 38 being a larger, composite data file made up of smaller data files or data file sections.

Since certain changes may be made in the above-described chargeable peer-to-peer file download system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for transferring data over a network, said method comprising the steps of:
obtaining at least one portion of a data file from a first client terminal over a network, based on a location of said at least one data file portion as received from one of a server terminal and a tracking application associated with the server terminal; and
transmitting accounting data to one of the tracking application and the server terminal, said accounting data relating to the transfer of the at least one data file portion by the first client terminal over the network.

2. The method of claim 1 wherein the accounting data is automatically securely generated and transmitted during or subsequent to said at least one data file portion being obtained.

3. The method of claim 2 further comprising:
obtaining a plurality of data file portions from a plurality of client terminals over the network, based on respective locations of said portions as received from one of the server terminal and the tracking application, said plurality of data file portions comprising the entirety of the data file, wherein the accounting data further relates to the transfer of said data file portions by the plurality of client terminals over the network.

4. The method of claim 3 wherein the accounting data includes at least one of a rate at which each data file portion was obtained over the network and an amount of data transmitted over the network for obtaining each of said data file portions.

5. The method of claim 3 further comprising:
obtaining an information file associated with the data file from said server terminal, said information file including a location of the tracking application for obtaining the locations of the data file portions from the tracking application.

6. The method of claim 5 further comprising, prior to obtaining said information file:
accessing a secure account on said server terminal; and
accessing a database on said server terminal from said account to select said information file, where said information file is one of a plurality of information files on said server terminal each relating to a different data file.

7. The method of claim 2 further comprising, subsequent to obtaining said at least one data file portion:
transmitting said at least one data file portion to a second client terminal over the network upon request from said second client terminal, said second client terminal being in communication with said server terminal; and
transmitting additional accounting data to one of said tracking application and said server terminal relating to the transmission of said at least one data file portion to said second client terminal.

8. The method of claim 7 wherein the additional accounting data includes at least one of (i) a rate at which each of the at least one data file portion was transmitted over the network to the second client terminal and (ii) an amount of data in each of said at least one data file.

9. The method of claim 2 further comprising:
receiving a plurality of network locations from said tracking application, said network locations being respectively associated with a plurality of client terminals each having said at least one data file portion; and
selecting one of said plurality of client terminals for obtaining said at least one data file portion.

10. A method for transferring data over a network, said method comprising the steps of:
transmitting to a first client terminal a location of at least one section of a data file stored on a second client terminal, upon request from the first client terminal; and
receiving accounting data originating from at least one of said first client terminal and said second client terminal, said accounting data relating to a transfer of said at least one data file section from the second terminal to the first terminal over the network.

11. The method of claim 10 wherein:
the location of the at least one data file section is transmitted from one of a server terminal and a tracker module, wherein at least one of said server terminal and said tracker module is in communication with at least one of said first client terminal and said second client terminal; and
the accounting data is received by at least one of said server terminal and said tracker module.

12. The method of claim 11 wherein:
the accounting data is received by said tracker module; and
the method further comprises transmitting said accounting data to the server terminal for billing purposes.

13. The method of claim 10 wherein the accounting data includes at least one of a rate at which each of the at least one data file section was transferred over the network and an amount of data in each of said at least one data file section.

14. The method of claim 13 further comprising:
establishing a secure connection with said at least one of the first client terminal and the second client terminal for securely receiving said accounting data there from.

15. The method of claim 10 further comprising:
establishing a secure connection with said at least one of the first client terminal and the second client terminal for securely receiving said accounting data there from.

16. The method of claim 10 further comprising:
transmitting to the first client terminal a location of each of a plurality of peer client terminals, said plurality of peer client terminals including the second client terminal, each of said peer client terminals having the at least on data file section stored thereon.

17. A file download system comprising:
a client module configured to run on a first client terminal for managing transfer of data files to said first client terminal;
wherein the client module is configured to obtain one or more network locations of each of said data files from one of a server terminal and a tracker module in communication with said server terminal;
and wherein the client module is configured to automatically securely transmit accounting data to one of said server terminal and said tracker module, said accounting data relating to the transfer of said data files from one or more second client terminals to the first client terminal, said one or more second client terminals being associated with the one or more network locations.

18. The system of claim 17 wherein the data files each comprise one section of a composite data file.

19. The system of claim 18 wherein the accounting data includes at least one of a rate at which each of said data files was transferred over the network and an amount of data in each of said data files, said accounting data being used by at least one of the tracker module and the server terminal for generating billing data.

20. The system of claim 19 wherein:
the client module is configured to access the tracker module for obtaining said one or more network locations of the data files, said tracker module being accessed by the client module at a network address of the tracker module contained in an information file, wherein the information file relates to the composite data file and is obtained from the server terminal; and
the information file is one of a plurality of information files stored on or otherwise accessible by the server terminal, each of said information files relating to a different composite data file sections of which are available for peer-to-peer transfer over said network.
